(19) United States
(12) Patent Application Publication
(10) Pub. No.: US 2006/0075262 A1
(43) Pub. Date: Apr. 6, 2006

(54) Apparatus and method for securely storing data

(75) Inventors: Chi-hurn Kim, Hwaseong-si (KR); Yong-kuk You, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/230,868

(22) Filed: Sep. 21, 2005

Related U.S. Application Data
(60) Provisional application No. 60/616,120, filed on Oct. 6, 2004.

(30) Foreign Application Priority Data
Oct. 18, 2004 (KR) 10-2004-0083240

(51) Int. Cl. G06F 12/14

(52) U.S. Cl. 713/193

(57) ABSTRACT

An apparatus and method for securely storing data. The apparatus for securely storing data in a predetermined device, includes: a key generator generating a protection key used to encrypt data based on a random number generated by inputting predetermined secret information in a predetermined random number generation function, and generation sequence information, which is information on a generation sequence of the random number, wherein the predetermined secret information is stored in a secure region, and the random number generation function can generate the protection key based on the generation sequence information and the secret information. As described above, the apparatus and method for storing data make it possible to securely store data even if the apparatus for storing data is replaced.

### CROSS-REFERENCE TO RELATED APPLICATIONS

This application claims the priority of U.S. Ser. No. 60/616,120, filed on Oct. 6, 2004 and Korean Patent Application No. 10-2004-0083240, filed on Oct. 18, 2004, in the Korean Intellectual Property Office, the disclosures of which are incorporated herein in their entireties by reference.

### BACKGROUND OF THE INVENTION

1. Field of the Invention

The present invention relates to an apparatus and method for storing data, and more particularly to an apparatus and method for storing data that make it possible to securely store data even if the apparatus for storing data is replaced, by using the data in an apparatus used as a replacement apparatus.

2. Description of the Related Art

A household electronic device such as a DVD player includes a hard disk embedded therein and stores contents such as audio/video (AV) data in the hard disk. Due to several reasons including copyright protection, the contents are encrypted using a predetermined encryption key and are stored in the hard disk. The encrypted contents are decrypted using a predetermined decryption key in order to reproduce the contents, and the decrypted contents are encrypted again using a predetermined encryption key and are stored in the hard disk. In order to secure one-time data protection, the contents are encrypted using a different encryption key whenever they are encrypted and stored in the hard disk.

FIG. 1A is a block diagram of the structure of a conventional data reproducing device such as a DVD player. Referring to FIG. 1A, the data reproducing device 10 comprises an external source 20 that provides contents, an external device 30 that uses the contents, i.e., reproduces the contents, and a data storage unit 40 that stores the contents.

The external source 20 refers to any device that provides the contents from outside of the data reproducing device 10, and for example, is a video tape, a CD, satellite receiving equipment, cable TV receiving equipment, and the like.

The external device 30 refers to a device that uses the contents, and for example, is an MPEG decoder, etc.

The data storage unit 40 encrypts the contents from the external source 20 in order to securely store the contents therein, decrypts the encrypted contents, and provides the external device 30 with the decrypted contents.

FIG. 1B is a block diagram of the internal structure of a conventional apparatus for storing data 100. The apparatus for storing data 100 comprises an encryptor 110, a key generator 120, a key storage unit 130, a decryptor 140, and a storage unit 150.

The key generator 120 generates a protection key 122 using random number generation. The protection key 122 is a key used to protect all the data stored in the data storage device 40, i.e. a key used to encrypt and decrypt the data. The protection key is different whenever it is generated due to the use of random number generation.

The encryptor 110 encrypts contents 102 from the external source 20 using the protection key 122, thereby generating encrypted contents 112 and storing them in the storage unit 150.

The protection key 122 generated by the key generator 120 is stored in the key storage unit 130. The key storage unit 130 is embodied as a secure region like, for example, a flash memory, etc.

When the external device 30 uses the contents 102, the decryptor 140 extracts encrypted contents 152 from the storage unit 150, extracts the protection key 122 from the key storage unit 130, and decrypts the encrypted contents 152 using the protection key 122, thereby generating decrypted contents 142 and providing the external device 30 with the decrypted contents 142.

Contents used in the external device 30 are encrypted in the encryptor 110 and stored in the storage unit 150. A protection key 124 used to encrypt the contents again is generated by the key generator 120. The protection key 124 is different from the protection key 122 used to firstly store the contents.

FIG. 2 is a flow chart describing a method of storing data using the apparatus for storing data shown in FIG. 1B.

In Operation 210, the key generator 120 generates the first protection key 122 using random number generation.

In Operation 220, the encryptor 110 encrypts the contents 102 using the first protection key 122, thereby generating the encrypted contents 112 and storing them in the storage unit 150.

In Operation 230, the first protection key 122 generated by the key generator 120 is stored in the key storage unit 130.

In Operation 240, the external device 30 uses the contents, for example, a DVD player reproduces the contents. In Operations 250 to 270, the decryptor 140 extracts the encrypted contents 152 from the storage unit 150, extracts the first protection key 122 from the key storage unit 130, and decrypts the encrypted contents 152 using the first protection key 122, thereby generating the decrypted contents 142 and providing the external device 30 with the decrypted contents 142, which are reproduced by the external device 30.

The reproduced contents are again encrypted in the encryptor 110 and are stored in the storage unit 150. That is, Operations 210 to 230 are repeated. The second protection key 124 used to encrypt the contents is generated by the key generator 120. The second protection key 124 is different from the first protection key 122 used to firstly store the contents. A different protection key is used to store the contents in order to secure one-time protection of the contents.

However, the foregoing apparatus and method for storing data have a problem when the apparatus 100 for storing data is installed in a new device due to after-sales service for the data reproducer 10. Suppose that first device DA includes first storage unit SA, and the first storage unit SA stores encrypted contents E (K1, C1) using a first protection key K1. The first device DA is replaced with the second device DB due to trouble of the first device DA. The first storage unit SA remains unchanged in order to maintain the encrypted contents E (K1, C1). That is, the first storage unit SA is installed in the second device DB.

In this case, the first protection key K1 is neither included in the second device DB nor known to an after-sales service center. Since the first protection key K1 is generated using random number generation, a problem occurs in which the second device DB cannot use, i.e., reproduce, the encrypted contents E (K1, C1) any more.

The problem frequently occurs when a storage medium is upgraded and replaced as well as the device has a defect.

### SUMMARY OF THE INVENTION

The present invention provides an apparatus and method for storing data capable of obtaining data stored in the apparatus for storing data, even if a device including the apparatus for storing data is replaced, through after-sales service, etc.

According to an aspect of the present invention, there is provided an apparatus for securely storing data in a predetermined device, including:

a key generator generating a protection key used to encrypt the data based on a random number generated by inputting predetermined secret information to a predetermined random number generation function, and generation sequence information, which is information on a generation sequence of the random number,

wherein the predetermined secret information is stored in a secure region, and the random number generation function can generate the protection key based on the generation sequence information and the secret information.

According to another aspect of the present invention, there is provided a method of securely storing data in a predetermined device, including:

key generating a protection key used to encrypt data based on a random number generated by inputting predetermined secret information in a predetermined random number generation function, and generation sequence information, which is information on a generation sequence of the random number,

wherein the predetermined secret information is stored in a secure region, and the random number generation function can generate the protection key based on the generation sequence information and the secret information.

### BRIEF DESCRIPTION OF THE DRAWINGS

The above and other features of the present invention will become more apparent by describing in detail exemplary embodiments thereof with reference to the attached drawings in which:

FIG. 1A is a block diagram of the structure of a conventional data reproducer such as a DVD player;

FIG. 1B is a block diagram of the internal structure of a conventional apparatus for storing data;

FIG. 2 is a flow chart describing a method of storing data using the apparatus for storing data shown in FIG. 1B;

FIG. 3 is a schematic diagram of an apparatus for storing data according to an exemplary embodiment of the present invention;

FIG. 4A is a schematic diagram of the general operation of the random number generation function used to encrypt data;

FIG. 4B is schematic diagram of a random number generation function;

FIG. 4C is a schematic diagram of another random number generation function;

FIG. 5A is a schematic diagram of the general operation of the random number generation function used to decrypt data;

FIGS. 5B and 5C are schematic diagrams of the operation of a random number generation function used to decrypt data in view of the random number generation function shown in FIGS. 4B through 4C;

FIG. 6 is a flow chart describing a method of storing data according to an exemplary embodiment of the present invention;

FIG. 7 is a schematic diagram of a method of performing device binding by allocating intrinsic secret information to each device;

FIG. 8 is a flow chart describing a method of extracting data stored in storage before a device is replaced due to a defect in the device;

FIG. 9 is a block diagram of operation relationship between a first device 900 and second device 902;

FIG. 10 is a flow chart describing another method of extracting data stored in storage before a device is replaced due to a defect in the device; and

FIG. 11 is a block diagram of operation relationship between a first device 1100 and second device 1102.

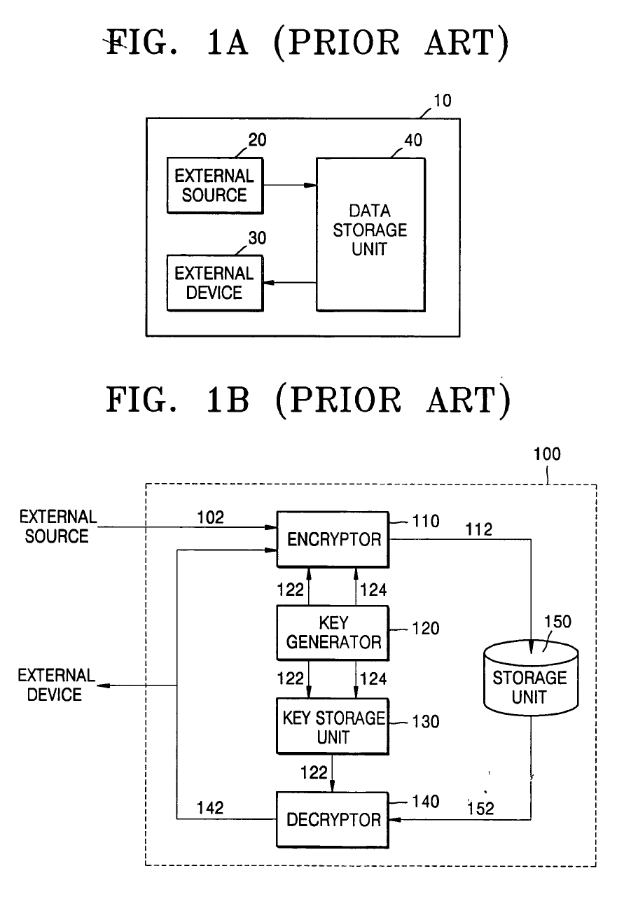

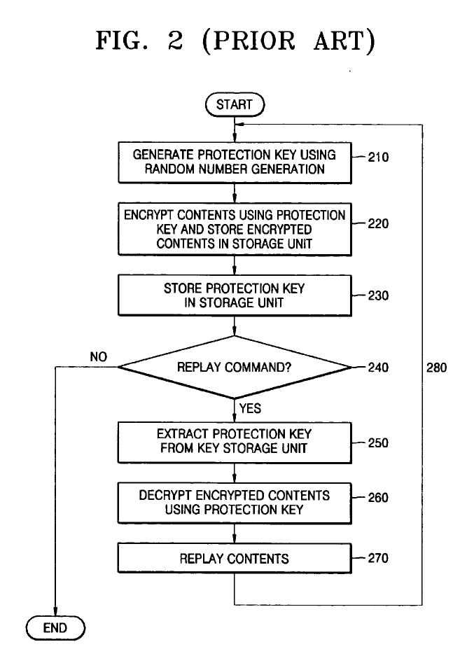

### DETAILED DESCRIPTION OF THE EXEMPLARY EMBODIMENTS

The present invention will now be described more fully with reference to the accompanying drawings.

Hereinafter, the term “device” means an apparatus for storing data according to an embodiment of the present invention, and refers to devices of any form that use data. For example, the device may be a reproducer such as a DVD player, a game machine that performs game data, a PDA, another mobile device, etc. The apparatus for storing data stores encrypted AV data, game data, etc., decrypts the data when necessary to provide the device with decrypted AV data, game data, etc., and again encrypts the data to securely store encrypted AV data, game data, etc.

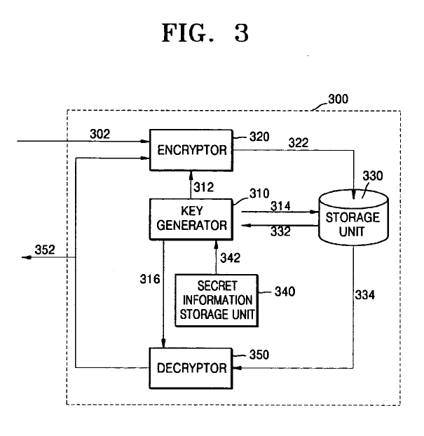

FIG. 3 is a schematic diagram of an apparatus for storing data according to an exemplary embodiment of the present invention. Referring to FIG. 3, the apparatus 300 for storing data comprises a key generator 310, an encryptor 320, a storage unit 330, secret information storage unit 340, and a decryptor 350.

Storing of data 302 input from an external source, and extracting of data 352 from the apparatus 300 for storing data, so that an external device can use the data 352, will now be separately described.

When the data 302 is input from an external source, the key generator 310 generates a protection key 312 by inputting secret information 342 into a random number generation function f() that uses a predetermined pseudo-random number generation algorithm. The protection key 312 used to encrypt and decrypt the data 302 is a random number generated by the random number generation function f().

The secret information 342 may be predetermined information used to generate a pseudo-random number like, for example, a seed, and is stored in a secure region of the apparatus 300 for storing data, i.e., the secret information storage unit 340.

The secret information 342 is information uniquely allocated to a device. Different secret information 342 causes a different random number to be generated, even though the random number generation function of is the same. Therefore, each apparatus for storing data has a different protection key 312, and an object of device binding can be accomplished.

The key generator 310 stores generation sequence information 314 which represents a random number generation sequence, using the random number generation function in the storage unit 330.

The encryptor 320 encrypts the data 302 using the protection key 312, thereby generating the encrypted data 322 and storing it in the storage unit 330.

When the external device uses the data 352, the key generator 310 generates a protection key 316 by extracting the generation sequence information 332 from the storage unit 330, extracting the secret information 342 from the secret information storage unit 340, and inputting the generation sequence information 332 and the secret information 342.

The decryptor 350 extracts encrypted data 334 from the storage unit 330, and decrypts the encrypted data 334 using the protection key 316, thereby generating the decrypted data 352.

The decrypted data 352 is transferred to the external device (not shown). Then, the decrypted data 352 is again encrypted by the encryptor 320 and is stored in the storage unit 330. For example, when the data 302 is AV data, the external device is an AV player that reproduces a video. Also, when the data 302 is information necessary for generating a contents key used to encrypt the contents, an external device may be a device that generates the contents key.

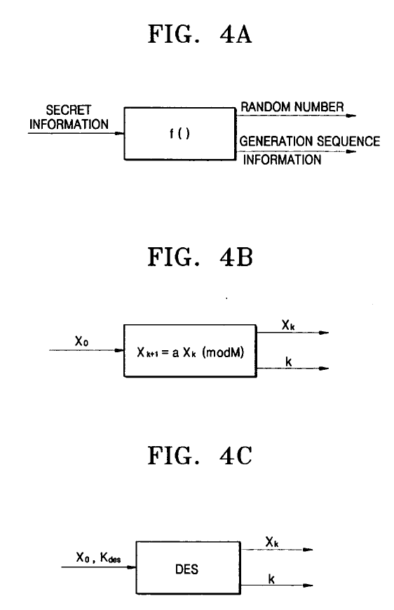

FIGS. 4A through 4C are schematic diagrams of the operation of a random number generation function used to encrypt data according to an exemplary embodiment of the present invention.

FIG. 4A is a schematic diagram of the general operation of the random number generation function used to encrypt data. Referring to FIG. 4A, a random number generation function of generates random numbers using secret information, and separately outputs a random number generation sequence. The random number generation function f() is a predetermined function in which predetermined random numbers are sequentially generated from predetermined secret information. The generation sequence information and random numbers are linked to each other and are stored in the storage unit 330.

FIG. 4B is schematic diagram of a random number generation function. Referring to FIG. 4B, the random number generation function f() is given as Equation 1,
f()=function which satisfies f(n)=Xₖ, Xₖ₊₁=αXₖ (mod M), wherein X₀=C (1)

where Xₖ is a k^{th} random number, k is generation sequence information, M is a predetermined decimal number, a is a constant, and X₀ is an initial value.

Referring to Equation 1, when the initial value X₀ is obtained, random numbers X₁, X₂, . . . , Xₖ, . . . , Xₙ are sequentially generated. The generated random numbers X₁, X₂, . . . , are not stored in the apparatus 300 for storing data. Instead, the k and Xk are stored in the storage unit 330.

FIG. 4C is a schematic diagram of another random number generation function. Referring to FIG. 4C, the random number generation function f() is given as Equation 2.
f()=function which satisfies Xₙ₊₁=DES(K_{des}, Xₙ) wherein X₀=C (2)

The random number generation function is a Data Encryption Standard (DES) encryption algorithm, encrypts a 128-bit input value Xₖ using DES key K_des, and generates a 128-bit output value Xₖ₊₁. The DES encryption algorithm is well known to a person having skill in the pertinent art.

Like in Equation 1, when the initial value X₀ is obtained, random numbers X₁, X₂, . . . , Xₖ, . . . , Xₙ are sequentially generated. The generated random numbers X₁, X₂, . . . , are not stored in the apparatus 300 for storing data. Instead, k and Xk are stored in the storage unit 330.

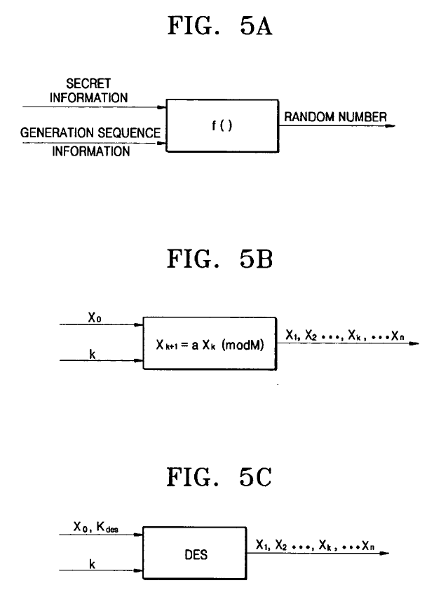

FIGS. 5A through 5C are schematic diagrams of the operation of a random number generation function used to decrypt data in view of the random number generation function shown in FIGS. 4A through 4C.

FIG. 5A is a schematic diagram of the general operation of the random number generation function used to decrypt data. Referring to FIG. 5A, the random number generation function f() generates random numbers using secret information and generation sequence information. When data is decrypted, the secret information is stored in a secure region of the apparatus 300 for storing data like, for example, a flash memory, and is extracted. When data is decrypted, the generation sequence information is stored in an insecure region of the apparatus 300 for storing data like, for example, a hard disk.

FIGS. 5B and 5C are schematic diagrams of the operation of a random number generation function used to decrypt data in view of the random number generation function shown in FIGS. 4B through 4C.

Referring to FIG. 5B, the key generator 310 generates a k^{th} random number using the initial value X₀ and Equation 1. Referring to FIG. 5C, the key generator 310 generates the k^{th} random number using the initial value X₀ and Equation 2.

Referring to FIGS. 4B and 5B, the secret information may be a coefficient instead of the initial value X₀. Referring to FIGS. 4C and 5C, the secret information may be the DES key K_des instead of the initial value X₀. In this case, the initial value X₀ may be opened.

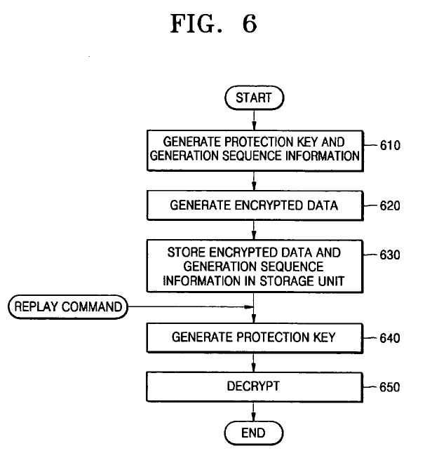

FIG. 6 is a flow chart describing a method of storing data according to an embodiment of the present invention.

In Operation 610, the key generator 310 generates a protection key used to encrypt data to be securely stored in a device and generation sequence information, which is information on a random number generation sequence, using a random number generation function that generates random numbers based on predetermined secret information stored in a secure region of a predetermined device. The random number generation function can generate the protection key based on the generation sequence information and secret information.

In Operation 620, the encryptor 320 encrypts data using the protection key, thereby generating encrypted data.

In Operation 630, the encryptor 320 and key generator 310 store the encrypted data and generation sequence information in an insecure region of the device, i.e., the storage unit 330.

In Operation 640, the key generator 310 generates the protection key by inputting the generation sequence information and secret information in the random number generation function when the device uses data. The protection key generated in Operation 610 is the same as the protection key generated in Operation 640 owing to a characteristic of the random number generation function.

In Operation 650, the decryptor 350 reads the encrypted data from the storage unit 330 and decrypts it using the protection key generated in Operation 640, thereby generating decrypted data.

According to the foregoing apparatus and method for storing data, although the storage unit 330 or the device is replaced, the protection key generated before the storage unit 330 or the device is replaced is the same as the protection key generated after the storage unit 330 or the device is replaced. The device DA includes the storage unit SA, and the storage unit SA includes encrypted data E (KA, data) using protection key KA. If a part other than the storage unit SA is replaced, i.e., the storage unit SA is installed in a new device DB, the device DB can decrypt the encrypted data E (KA, data) stored in the storage unit SA, because a new key generator of the device DB can generate the protection key KA from generation sequence information included in the storage unit SA and secret information corresponding to the storage unit SA. The secret information corresponding to the storage unit SA is recorded in the device DB by an after-sales service center.

According to the foregoing apparatus and method for storing data, device binding can be accomplished since secret information is intrinsic to each device. Device binding means when a device A is authorized to use data, a device B cannot use the data, even if a storage medium having the data is installed in device B. Generally, a data provider, i.e., a contents provider requires device binding to a device provider, i.e., a reproducer manufacturer.

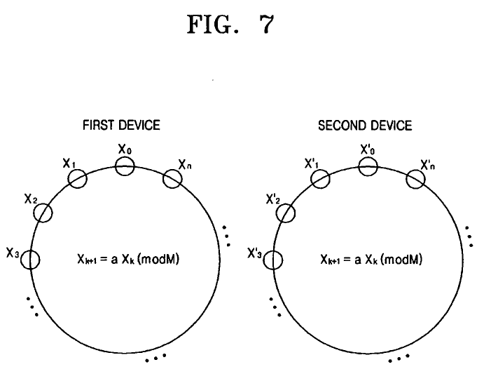

FIG. 7 is a schematic diagram of a method of performing device binding by allocating intrinsic secret information to each device. Both first and second devices generate random numbers using the random number generation function satisfying Xₖ₊₁=aXₖ(mod M) shown in FIGS. 4B and 5B. Both devices use the same random number generation function. However, since the initial value X₀ of the first device is different from the initial value X₀ of the second device, random numbers generated by the first device, X₀, X₁, X₂, . . . , Xₙ and random numbers generated by the second device, X_{0′}, X_{1′}, X_{2′}, . . . , X_{n′} are different from each other.

For example, the device DA encrypts data using protection key X₂, stores encrypted data in the storage unit SA, and the storage unit SA is installed in the device DB. Since the device DB includes its secret information sec_B (i.e., initial value X_{0′}) and excludes secret information sec_A (i.e., the initial value X₀) of the device DA, the device DB cannot generate the protection key X₂ even if both devices use the same random number generation function.

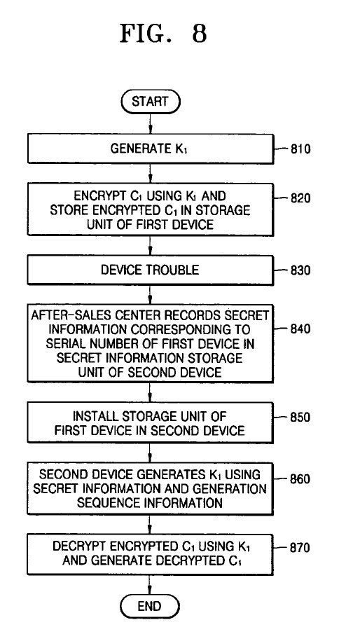

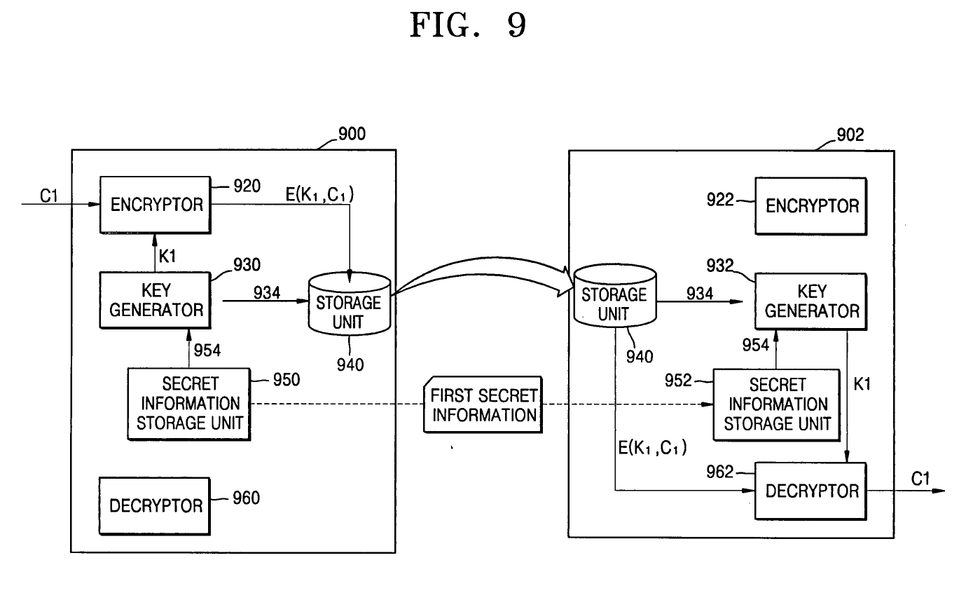

FIG. 8 is a flow chart describing a method of extracting data stored in storage before a device is replaced due to a defect. FIG. 9 is a block diagram of operation relationship between a first device 900 and second device 902. The method shown in FIG. 8 will now be described with reference to FIG. 9.

In Operation 810, a key generator 930 of the first device 900 generates a first protection key K₁ using first secret information 954 from secret information storage unit 950 of the first device 900. At this time, generation sequence information 934 of the first protection key K₁ is also generated and stored in storage unit 940 of the first device 900.

In Operation 820, an encryptor 920 of the first device 900 encrypts data C₁ using the first protection key K₁, generates encrypted data E (K₁, C₁), and stores the encrypted data E (K₁, C₁) in the storage unit 940 of the first device 900. The first device 900 also includes a decryptor 960.

In Operation 830, due to a defect of the first device 900, the first device 900 is replaced with the second device 902 while the data E (K₁, C₁) remains unchanged. That is, the storage unit 940 of the first device 900 is installed in the second device 902.

In Operation 840, the after-sales service center records secret information corresponding to the storage unit 940 of the first device 900, i.e., the first secret information 954 in secret information storage unit 952 of the second device 902. The after-sales service center has tables corresponding to the respective first and second devices and secret information, and confirms a serial number of the storage unit 940 of the first device 900 using the tables in order to determine what the first secret information 954 is.

In Operation 850, the after-sales service center installs the first storage unit 940 in the second device 902. Therefore, the second device 902 includes the storage unit 940 of the first device 900 in which the encrypted data E(K₁, C₁) and generation sequence information 934 are recorded, and secret information storage unit 952 of the second device 902 in which the first secret information 954 is recorded.

In Operation 860, a key generator 932 of the second device 902 extracts the first secret information 954 from the secret information storage unit 952 of the second device 902, extracts the generation sequence information 934 from the storage unit 940 of the first device 900, and generates the first protection key K₁ using the first secret information 954, the generation sequence information 934 and a random number generation function. The first device 900 and second device 902 have the same random number generation function.

In Operation 870, a decryptor 962 of the second device 902 extracts the encrypted data E(K₁, C₁) from the storage unit 940 of the first device 900, decrypts the encrypted data E(K₁, C₁) using the first protection key K₁ generated in Operation 860, and generates decrypted data C₁. The second device 902 also includes an encryptor 922.

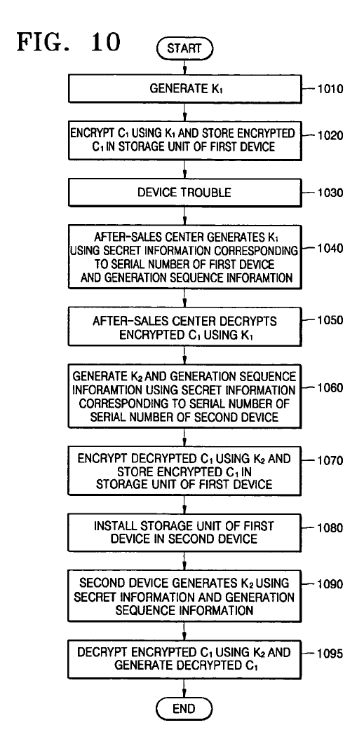

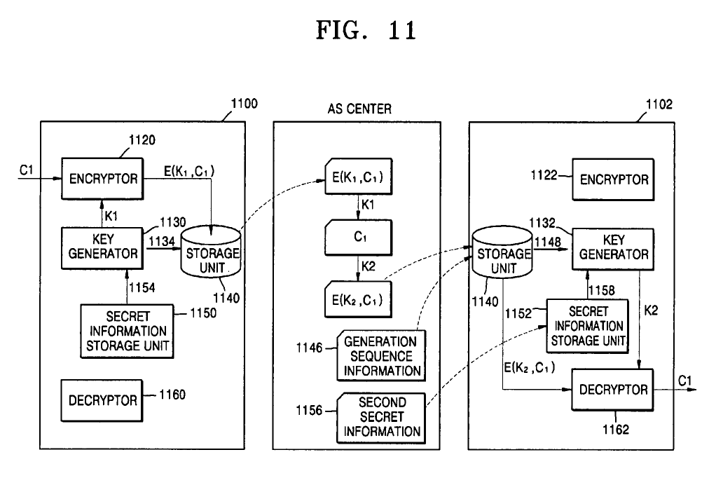

FIG. 10 is a flow chart describing another method of extracting data stored in storage before a device is replaced due to a defect. FIG. 11 is a block diagram of an operation relationship between a first device 1100 and a second device 1102. The method shown in FIG. 10 will now be described with reference to FIG. 11.

In Operation 1010, a key generator 1130 of the first device 1100 generates a first protection key K, using first secret information 1154 from a secret information storage unit 1150 of the first device 1100. At this time, generation sequence information 1134 of the first protection key K₁ is also generated and is stored in storage unit 1140 of the first device 1100.

In Operation 1020, an encryptor 1120 of the first device 1100 encrypts data C₁ using the first protection key K₁, generates encrypted data E (K₁, C₁), and stores the encrypted data E (K₁, C₁) in the storage unit 1140 of the first device 1100. The first device 1 100 also includes a decryptor 1160.

In Operation 1030, due to a defect of the first device 1100, the first device 1100 is replaced with the second device 1102 while the data E (K₁, C₁) remains unchanged. That is, the storage unit 1140 of the first device 1100 is installed in the second device 1102.

In Operation 1040, the after-sales service center generates the first protection key K₁ using first secret information 1154 corresponding to the storage unit 1140 of the first device 1100 and the generation sequence information 1134 of the first protection key K₁. The generation sequence information 1134 of the first protection key K₁ can be extracted from the storage unit 1140 of the first device 1100. The after-sales service center has tables each corresponding to the first and second devices and secret information, and confirms a serial number of the storage unit 1140 of the first device 1100 using the tables in order to determine what the first secret information 1154 is.

In Operation 1050, the after-sales service center decrypts the encrypted data E(K₁, C₁) using the first protection key K₁ to generate decrypted data C₁. The encrypted data E(K₁, C₁) can be extracted from the storage unit 1140 of the first device 1100.

In Operation 1060, the after-sales service center generates a second protection key K₂ using second secret information 1156 corresponding to a serial number of the second device 1102. At this time, generation sequence information 1146 of the second protection key K₂ is also generated and is stored in storage unit 1140 of the first device 1100.

In Operation 1070, the after-sales service center encrypts data C1 decrypted in Operation 1050 using the second protection key K₂, generates encrypted data E (K₂, C₁), and stores the encrypted data E ( K₂, C₁) in the storage unit 1140 of the first device 1100.

In Operation 1080, the after-sales service center installs the first storage unit 1140 in the first device 1100 in the second device 1102, and records the second secret information 1156 of Operation 1060 in the secret information storage unit 1152 of the second device 1102.

In Operation 1090, a key generator 1132 of the second device 1102 generates the second protection key K₂ using the generation sequence information 1148 of the second protection key K₂ and secret information 1158. The first device 900 and second device 902 have the same random number generation function.

In Operation 1095, a decryptor 1162 of the second device 1102 extracts the encrypted data E(K₂, C₁) from the storage unit 1140 of the first device 1100 and decrypts the encrypted data E(K₂, C₁) using the second protection key K₂ generated in Operation 109 to generate decrypted data C₁. The second device 1102 also includes an encryptor 1122.

It is possible for an exemplary embodiment of the present invention to be realized on a computer-readable recording medium as a computer-readable code. Computer-readable recording mediums include every kind of recording device that stores computer system-readable data. ROMs, RAMs, CD-ROMs, magnetic tapes, floppy discs, optical data storage unit, etc. are used as a computer-readable recording medium. Computer-readable recording mediums can also be realized in the form of a carrier wave (e.g., transmission through Internet).

As described above, an apparatus and method for storing data make it possible to obtain data stored in the apparatus for storing data by separately storing information on a random number generation sequence and secret information on random number generation although a device including the apparatus for storing data is replaced through after-sales service, etc.

An apparatus and method for storing data make it possible to accomplish device binding to allow contents to be used in a single device by allocating intrinsic secret information to each device.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the present invention is defined not by the detailed description of the invention but by the appended claims, and all differences within the scope of the present invention will be construed as being included in the present invention.

What is claimed is:

1. An apparatus for securely storing data in a predetermined device, comprising:
a key generator generating a protection key used to encrypt the data, said protection key based on:
a random number generated by inputting predetermined secret information to a predetermined random number generation function, and
generation sequence information, which is information on a generation sequence of the random number,
wherein the predetermined secret information is stored in a secure region, and the random number generation function generates the protection key based on the generation sequence information and the secret information.

2. The apparatus of claim 1, further comprising:
an encryptor encrypting the data using the protection key to generate encrypted data;
a storage unit storing the encrypted data and the generation sequence information; and
a secret information storage unit securely storing the secret information with an external access blocked.

3. The apparatus of claim 1, wherein the key generator generates the protection key by inputting the generation sequence information and the secret information in the random number generation function when the device uses the data.

4. The apparatus of claim 1, further comprising:
a decryptor reading encrypted data from the storage unit and decrypting the encrypted data using the protection key to generate decrypted data when the device uses the data.

5. The apparatus of claim 1, wherein the random number generation function generates a different random number when different secret information is input to the random number generation function, even if the generation sequence information is the same.

6. The apparatus of claim 5, wherein the secret information is unique information allocated to each device so that device binding can be accomplished.

7. The apparatus of claim 1, wherein the key generator generates the random number using a DES algorithm, and the secret information is a Data Encryption Standard (DES) key.

8. The apparatus of claim 4, wherein the data is audio/video (AV) contents, and the decryptor reads the encrypted data from the storage unit when the device commands reproduction of the AV contents, and decrypts the encrypted data using the protection key to generate decrypted data.

9. A method of securely storing data in a predetermined device, comprising:
generating a protection key used to encrypt data, said protection key based on:
a random number generated by inputting predetermined secret information in a predetermined random number generation function, and
generation sequence information, which is information on a generation sequence of the random number, and
storing the predetermined secret information in a secure region, wherein the random number generation function generates the protection key based on the generation sequence information and the secret information.

10 The method of claim 9, further comprising:
encrypting the data using the protection key to generate encrypted data;
storing the encrypted data and the generation sequence information in an insecure region of the device; and
generating a decryption key generating the protection key by inputting the generation sequence information and the secret information to the random number generation function when the device uses the data.

11. The method of claim 9, further comprising:
decrypting reading encrypted data from the storage unit and decrypting the encrypted data using the protection key to generate decrypted data when the device uses the data.

12. The method of claim 9, wherein the random number generation function generates a different random number when different secret information is input to the random number generation function, even if the generation sequence information is the same.

13. The method of claim 12, wherein the secret information is intrinsic information allocated to each device so that device binding can be accomplished.

14. The method of claim 9, wherein the key generating generates the random number using a DES algorithm, and the secret information is a DES key.

15. The method of claim 9, wherein the data is audio/video (AV) contents, and the decrypting reads the encrypted data from the storage unit when the device commands to reproduce the AV contents, and decrypts the encrypted data using the protection key to generate decrypted data.

16. A computer readable medium having embodied thereon a computer program for executing the method of claim 9.
